(19) United States
(12) Patent Application Publication
(10) Pub. No.: US 2005/0284017 A1
(43) Pub. Date: Dec. 29, 2005

(54) Biodegradable insect bait station

(76) Inventor: Phillip A. Kongshaug, Racine, WI (US)

Correspondence Address: S.C. JOHNSON & SON, INC., 1525 HOWE STREET, RACINE, WI, 53403-2236, US

(21) Appl. No.: 10/880,365

(22) Filed: Jun. 29, 2004

(51) Int. Cl. A01M 1/20

(52) U.S. Cl. 43/131; 43/132.1

(57) ABSTRACT

A biodegradable outdoor insect bait station for offering a toxic bait to a target insect. The bait station includes a bait matrix together with a housing for holding the bait matrix. The bait matrix has a core of toxic bait material and a biodegradable coating. When placed outdoors, moisture permeates the coating and liquifies the bait core making the entire matrix a food source for the target insect. The housing for holding the bait matrix may also be made biodegradable.

### BACKGROUND OF THE INVENTION

The present invention relates in general to an apparatus for dispensing pesticides, and more particularly to a biodegradable outdoor insect bait station adapted to be anchored securely in the ground.

One of the most popular and effective methods of combating crawling insects such as ants is to use poisonous bait which is commonly positioned around or near the insect nest or near where insects gather food. According to their usual food gathering habits, crawling insects will feed on the poisonous bait and take some of the bait with them back to their nests or homes where the bait is shared with other insects, preferably the queen, and as a result kill a large number of insects.

Various devices typically referred to as insect bait stations have been utilized to present bait to crawling insects, and are well known. Typical examples of outdoor insect bait stations are disclosed in U.S. Pat. Nos. 2,837,861; 4,277,907; 4,485,582; 5,325,626; 5,746,021; 5,918,410; 6,164,010; 6,219,960; 6,298,597; 6,401,384; 6,467,216; 6,474,016 and 6,497,070. Each of the bait stations disclosed in the above patents generally include a sealable container and a spike or stake attached thereto for insertion into the ground. A plurality of access holes are provided either in the stake or in the container which allow the crawling insects to enter the interior of the container to feed on the poisonous bait.

There are also various devices designed to be embedded in the ground for delivery of pesticides to target insects or for the delivery of other materials to the ground that are provided with components that may be biodegradable or otherwise sacrificial. Typical examples of such structures are disclosed in U.S. Pat. Nos. 3,302,325; 3,962,822; 4,333,265; 4,336,669; 6,159,489; 6,202,342; and 6,419,943. Biodegradable structures advantageously eliminate the need to seek out the remnants of insect bait stations and dispose of them at a later date after the poisonous bait is depleted. There remains a need, however, for an improved biodegradable outdoor insect bait station.

### SUMMARY OF THE INVENTION

The present invention provides a biodegradable outdoor insect bait station for offering a toxic bait to a target insect. The bait station comprises a bait matrix together with a housing for holding the bait matrix. When the bait station is placed outdoors, the bait matrix biodegrades providing an appealing food source for a target insect.

The bait matrix comprises a core of bait material which includes a pest controlling amount of an active ingredient toxic to the target insect, and a biodegradable coating covering at least a portion of the bait core. When placed outdoors, moisture permeates the coating and liquefies the core making the entire matrix a food source for the target insect. Furthermore, liquefied bait can leach back into and through the coating to become directly available to the target insect. Herein, a “liquefied” material shall include but not be limited to materials rendered literally liquid, as well as materials moistened or made sticky. The housing includes at least one opening to permit the target insect ingress and egress from the interior of the bait station where it can feed on the bait. The housing advantageously permits ease of handling the bait station, protection for the handler from the bait material, and ready access by ants to the bait.

In one particularly preferred embodiment, the bait matrix is in the form of a spike having an inner core of solid bait material covered by an outer rigid sheath of biodegradable material, such as paper, with a head portion disposed within the housing and a longitudinally extending stake projecting through an aperture in the housing. In this embodiment, the bait station can be inserted into the ground until the housing is substantially flush with the ground so that it is inconspicuous and the bait material contained in the matrix and within the housing is inacessible to household pets. The outer rigid sheath of the matrix is biodegradable and the housing for holding the matrix may also be composed of a biodegradable material which eliminates the need to seek out remnants of the station and dispose of them at a later date after the toxic bait is depleted.

### BRIEF DESCRIPTION OF THE DRAWINGS

The drawings illustrate the best mode presently contemplated of carrying out the invention.

In the drawings:

FIG. 1 is a perspective view of a biodegradable insect bait station constructed in accordance with the principles of the present invention;

FIG. 2 is an exploded perspective view of the components of the insect bait station; and

FIG. 3 is a longitudinal cross-sectional view of the insect bait station.

### DETAILED DESCRIPTION OF THE INVENTION

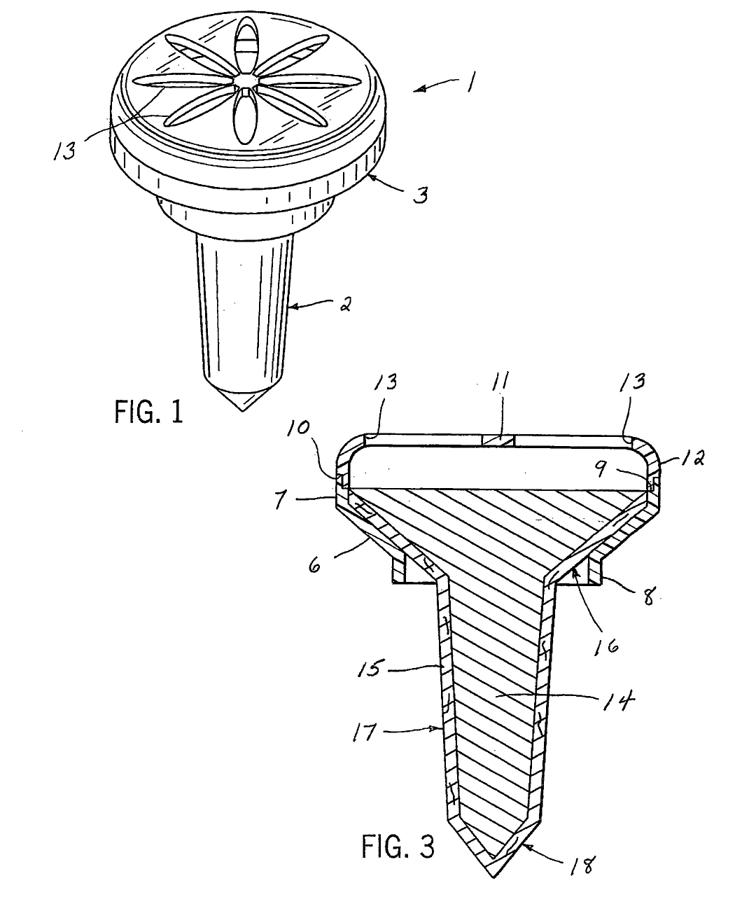

Referring now to the drawings, FIGS. 1-3 illustrate a biodegradable insect bait station generally designated by the numeral 1 and constructed in accordance with the principles of the present invention. The bait station 1 is comprised of a bait matrix generally designated by the numeral 2 together with a hollow housing generally designated by the numeral 3 for holding the bait matrix 2. When the bait station 1 is placed outdoors, the bait matrix 2 provides an appealing food source for a target insect. Furthermore, preferably bait matrix 2 is selected to absorb moisture from its surroundings, liquefying the food source and further increasing its appeal to a target insect. It should be noted that although bait station 1 is designed primarily for use outdoors, indoor use is also possible by modifying the configuration of the bait matrix 2. In addition, bait station 1 is intended primarily for offering a toxic bait to a target insect which is preferably a crawling insect such as an ant, a cockroach, a spider, a beetle, a centipede and the like.

As used herein, the term “biodegradable” refers to a material that has the ability to break down relatively quickly by biological means (e.g. by microorganisms) or by exposure to sunlight, air, moisture, or other environmental conditions found its surroundings into the raw materials of nature and eventually disappear into the environment. Generally, any plant based, animal based, or natural mineral based product has the capability to biodegrade, but products made from manmade petrochemical compounds generally are not considered to be biodegradable due to the length of time for such materials to actually break down in nature as a result of the action of microorganisms. Recently, however, biodegradable plastic has been introduced. In order to accomplish this, natural ingredients such as corn starch or vegetable oil are added to render the plastic biodegradable. Examples of such biodegradable plastics include Ultradur-B available from BASF, and Eastar Bio available from Eastman Chemical Company. Biodegradable materials generally comprise one or more of paper, cotton, and modified starches or cellulose acetate.

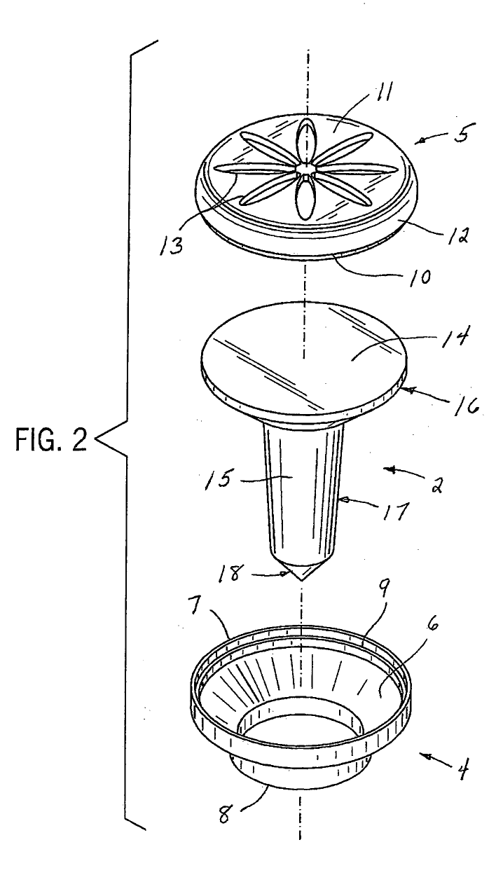

The housing 3 for holding bait matrix 2 is itself comprised of two components, namely, a generally annular shaped bait holder 4 and a cap 5. As noted above, both the bait holder 4 and cap 5 may be composed of a biodegradable material, and in the preferred embodiment comprise biodegradable plastic. As illustrated best in FIGS. 2 and 3, bait holder 4 has a frustum-shaped outer wall 6 that extends upwardly to an upper rim 7 defining an open top and extends downwardly to a lower rim 8 defining an open bottom or aperture. Both the upper rim 7 and lower rim 8 are annular in shape with the diameter of upper rim 7 being greater than the diameter of lower rim 8. Frustum-shaped outer wall 6 extends between rims 7 and 8 and provides a tapered surface disposed at an angle of about 45° from a vertical plane that extends longitudinally and parallel with respect rims 7 and 8. Upper rim 7 includes an annular recess 9 formed therein which cooperates with a like recess 10 formed in cap 5 to provide a snap fit arrangement between cap 5 and bait holder 4.

Cap 5 encloses the open top of bait holder 4 and comprises a relatively flat ceiling 11 that spans the open top of holder 4 and extends to an outer periphery having a diameter substantially matching the diameter of upper rim 7. Cap 5 also includes an annular rim 12 extending downwardly from the outer periphery of cap ceiling 11. Rim 12 includes, as described above, an annular recess 10 at its lower edge which cooperates with recess 9 to provide a snap-fit arrangement for cap 5 on bait holder 4. Cap 5 also includes at least one opening 13 formed in ceiling 11 to provide access to toxic bait by a target insect, i.e. to permit a target insect ingress to the hollow interior of housing 3 and egress therefrom. As shown best in FIGS. 1 and 2, there are eight equi-angularly spaced apart oblong shaped openings 13 formed in ceiling 11. As apparent to one skilled in the art, the number of openings 13 as well as the shape of each opening 13 may be varied as desired so long as a target insect has access to the interior of hollow housing 3 via those openings 13.

As shown best in FIG. 3, bait matrix 2 is comprised of a core 14 containing a bait with a pest controlling amount of an active ingredient toxic to a target insect, and a biodegradable coating 15 covering at least a portion of the bait core 14. The insect bait is preferably in solid form, but may also be a liquid, a liquid absorbed onto a substrate such as a cellulosic material, a gel, or a semi-solid composition. As used herein, the term “bait” refers to any of a number of toxic formulations poisonous to a target insect, such as an ant, which are well known in the art. Preferably, the bait is of the type having a delayed kill action so that crawling insects will feed on the poisonous bait and take some of the bait with them back to their nests or homes where the bait is shared with other insects and as a result kill a large number of insects. Examples, of a suitable insecticidal active ingredient toxic to insects include abamectin, imidachloprid, hydramethylnon, boric acid, sodium borate, fipronil and/or perfluorosulfonyl compounds, as well as others known to those skilled in this art, commonly employed to kill crawling insects. These insecticidal actives may be formulated like most hard candies using sugars, corn syrup and water. The term “pest controlling amount of active ingredient” refers to providing an effective amount of the insecticidal active sufficient to kill the target insect. Such amounts are well known in the art and may be varied depending upon the target insect as well as the rate of kill desired. However, typically insecticidal actives will be incorporated into a formulation in an amount of from about 0.001% by weight to about 10% by weight which would be adequate to provide a pest controlling amount of the active ingredient. An example of a suitable bait-toxicant formulation comprises: hydramethylnon (at 0.51% by weight) as the insecticidal active, oleic acid (at 0.35% by weight) as a solvent for the active, peanut oil (at 0.64% by weight) as a solvent for the active, sorbitan monooleate (at 0.30% by weight) as an emulsifier, cane sugar (at 52% by weight) as a food source, corn syrup (at 32% by weight) as a food source, and water (at 14.20% by weight) as a solvent. Another example of a suitable bait toxicant comprises: boric acid (at 2% by weight) as the insecticidal active ingredient, sugar and corn sweetener (at 15% by weight) as a food source, a preservative such as that commonly sold under the trademark “Legend MK” (at 0.2% by weight), carageenan (at 1.2% by weight) as a thickener, and water (81.6% by weight) as a solvent. Once dried, the above liquid formulations become solid and hard candy-like. Once exposed to moisture, it will absorb the moisture, liquefy and provide a food source for the target insect. It should also be noted that moisture absorption by bait core 14 can be regulated by the choice of sugars and syrups as is well known in the art. Also, feeding acceptance by the target insect can be enhanced by the inclusion of additional ant feeding stimulants such as non-caloric sweeteners such as sorbitol, xanitol, saccharin, or aspartame, as well as proteins such as yeast derivatives, poultry or other meat meal, or soy protein extracts, which is also well known in the art.

Coating 15 is made of a biodegradable material and covers at least a portion of bait core 14. Preferably, the biodegradable coating 15 is formed of a rigid biodegradable material such as paper. However, coating 15 could also comprise a thin film of biodegradable plastic material if desired as well as any other biodegradable material which will initially protect bait core 14 but will permit moisture to permeate therethrough and liquefy the bait core 14. A portion of the liquefied bait core 14 may also leach back through the coating 15 to become directly available to a feeding target insect.

In the preferred embodiment, bait matrix 2 is in the form of a longitudinally extending spike having a head portion 16 disposed within bait holder 4, a stake portion 17 projecting through the open bottom or aperture of bait holder 4 to extend outside of bait holder 4 and terminate at a cone-shaped tip 18. As shown best in FIG. 3, the bait matrix 2 comprises a solid core 14 containing a bait with a pest controlling amount of an active ingredient toxic to the target insect, and a biodegradable rigid sheath 15 covering at the least the stake portion 17 and tip 18 of the spike. As illustrated, stake portion 17 is frustum-shaped and has a taper of 45° to match the taper of the outer wall 6 of bait holder 4 so that the head portion 16 will nest within bait holder 4. The stake portion 17 of the spike will thus extend from the open bottom bait holder 4 for easy insertion into the ground.

In use, the stake portion 17 and cone-shaped tip 18 are pushed into the ground until housing 3 is substantially flush with the surface of the ground. After being pushed into the ground, moisture will permeate the coating or sheath 15 and liquefy the bait core 14 thus making the entire bait matrix 2 an appealing food source for a target insect. Since the entire bait station 1 may be biodegradable, bait station 1 eliminates the need to seek out the remnants thereof and dispose them at a later date after the bait matrix is depleted.

While this invention has been described with reference to what is currently considered to be the preferred embodiment, it is to be understood that the invention is not limited to the disclosed embodiment. On the contrary, the invention is intended to cover various modifications and equivalent arrangements included within the spirit and scope of the appended claims. For example, the bait matrix 2 need not necessarily be in the form of a spike, but may take other configurations as desired, especially if adapted for indoor use. Thus, the scope of the following claims is to be accorded the broadest interpretation so as to encompass all such modifications and equivalent structures and functions.

1. A bait station for offering a bait to a target insect, comprising:
a bait matrix having a core containing a bait with a pest-controlling amount of an active ingredient toxic to a target insect, and a biodegradable coating covering at least a portion of said bait core; and
a housing for holding said bait matrix, said housing having at least one opening providing access to said bait core by said target insect.

2. The bait station of claim 1 wherein said housing further includes an aperture therein and said bait matrix projects through said aperture.

3. The bait station of claim 2 wherein said bait matrix is in the form of a longitudinally extending spike.

4. The bait station of claim 3 wherein said spike includes a head portion disposed within said housing and a stake portion disposed outside of said housing.

5. The bait station of claim 4 wherein the head portion of said spike is frustum-shaped.

6. The bait station of claim 4 wherein the stake portion of said spike includes a cone-shaped tip.

7. The bait station of claim 4 wherein said biodegradable coating surrounds at least the stake portion of said spike.

8. The bait station of claim 7 wherein said biodegradable coating comprises a rigid sheath.

9. The bait station of claim 2 wherein said core is in solid form, and said biodegradable coating is formed of a rigid material.

10. The bait station of claim 1 wherein said housing comprises a biodegradable housing.

11. The bait station of claim 10 wherein said biodegradable housing is composed of a biodegradable plastic.

12. The bait station of claim 1 wherein said coating is capable of transmitting moisture from its environment to liquefy a portion of the bait.

13. The bait station of claim 12 wherein said coating is capable of admitting liquefied bait therethrough, whereby the liquefied bait can become directly available to target insects.

14. A bait station for offering a bait to a target insect, comprising:
a hollow housing comprising a bait holder and a cap, said bait holder having an outer wall that extends upwardly to an upper rim defining an open top and downwardly to lower rim defining an open bottom, and said cap enclosing the open top of said bait holder and having at least one opening to permit a target insect ingress thereto and egress therefrom; and
a bait matrix in the form of a longitudinally extending spike having a head portion disposed within said bait holder and a stake portion projecting through said open bottom and disposed outside of said bait holder, said bait matrix comprising a solid core containing a bait with a pest-controlling amount of an active ingredient toxic to a target insect, and a biodegradable rigid sheath covering at least the stake portion of said spike.

15. The bait station of claim 14 wherein the stake portion of said spike is frustum-shaped and said outer wall is frustum-shaped between said upper and lower rims to permit said head portion to nest therein.

16. The bait station of claim 14 wherein the stake portion of said spike includes a cone-shaped tip.

17. The bait station of claim 14 wherein said rigid sheath comprises paper.

18. The bait station of claim 14 wherein said housing comprises a biodegradable housing.

19. The bait station of claim 18 wherein said biodegradable housing is composed of a biodegradable plastic.

20. The bait station of claim 14 wherein said rigid sheath is capable of transmitting moisture from its environment to liquefy a portion of the bait.

21. The bait station of claim 20 wherein said rigid sheath is capable of admitting liquefied bait core therethrough, whereby liquefied bait can become directly available to target insects.
